(19) United States
(12) Patent Application Publication
(10) Pub. No.: US 2002/0051622 A1
(43) Pub. Date: May 2, 2002

(54) Video deck, video deck control method and video deck control program recording medium

(76) Inventor: Noriyuki Fujii, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 09/901,911

(22) Filed: Jul. 11, 2001

(30) Foreign Application Priority Data
Jul. 12, 2000 (JP) JU2000-4917

(51) Int. Cl. H04N 5/783; H04N 5/91

(52) U.S. Cl. 386/68; 386/81; 386/83

(57) ABSTRACT

The problem that a target stop position can not be searched accurately when videotaping is started midway on a blank videotape having no control signals thereon is solved as follows. In order to locate the target stop position while the counter display counts up or down as the tape is transported, the action to stop the tape is started when the counter display reads the same value as in the target stop position. Then, when the tape is reversed to offset the overrun due to inertia, the tape transport is controlled so that the reverse motion stops when a prescribed number of control signals have been detected and the display shows that the time required to reach the target stop position becomes a prescribed time or less. Consequently, the target stop position can be searched accurately, whether or not there are recorded control signals on the tape.

### BACKGROUND OF THE INVENTION

1. Field of the Invention

This invention relates to a video deck which accurately searches the start of a recorded sequence, a video deck control method therefor and a video deck control program recording program therefor.

2. Description of the Prior Art

Some currently available video decks have a function for video recording, called a counter memory stop, which memorizes the tape position at the recording start point and searches that tape position after the recording is over. In such video decks, the tape position at the recording start point is searched as follows: the counter display is reset to “0:00:00” (0 hr. 00 min. 00 sec. ) at the tape position corresponding to the recording start point; and as recording proceeds, the counter display counts up, then upon completion of recording, rewinding is done until the counter display reads “0:00:00” again.

Many of the recent video deck models have a function for forwarding and rewinding the tape quickly. When the tape is forwarded or rewound using such a fast-forward/rewind function, the tape is made to stop gently in order not to be damaged. Therefore, to search the recording start position of the tape based through the above-said counter memory stop function using such a fast-rewind function, conventional video decks work as follows: fast-rewinding begins upon completion of recording; then when the display reads “−0:00:01”, the action to stop tape transport begins and after the tape is stopped, in order to offset the overrun, normal forwarding takes place until the display reads “0:00:00”.

In the magnetic recording and reproducing device disclosed in Japanese Patent Prepublication No. 62-204457 where reproducing can be done at a higher speed than a normal reproducing speed, in the high speed reproducing mode, the quantity of tape transferred from a time when a signal to stop a tape transfer is inputted, to the time when the tape transfer stops, is detected and after the tape transfer stops, the tape is rewound by the detected quantity.

The above-mentioned conventional video decks have the following problem.

In those video decks, usually time count-up or countdown takes place according to the number of detected control signals recorded on the tape. If the tape has an area where no control signals are recorded, for example, when recording is started midway on a blank tape, no count-up or count-down takes place, although the display reads “0:00:00” at the tape position corresponding to the recording start point, no further count-down occurs and the counter never reaches “−0:00:01” because there are no control signals before that tape position. As a consequence, fast-forwarding cannot be started according to the above-mentioned sequence and thus it is impossible to search the recording start position of the tape accurately.

Also the method described in Japanese Patent Prepublication No. 62-204457 has no means to search the start of a recorded sequence accurately for a videotape having an area where no control signals are recorded.

### SUMMARY OF THE INVENTION

In view of the above circumstances, the present invention aims to provide a video deck which searches the target stop position on the tape accurately, whether or not control signals are recorded on the tape.

According to one aspect of the present invention, a video deck comprises the following:

a tape drive mechanism for fast-forwarding or fast-rewinding the tape in a loaded video cassette at various transport speeds;

a signal input/output head which records on/reads from the tape, NTSC control signals and prescribed video signals while the tape is being transported by the tape drive mechanism;

a counter which resets the count at the video recording start position and adds to/subtracts from the reset count either the number of control signals for the signal input/output head to record on the tape or the number of control signals for the signal input/output head to detect from the tape, or a combination of these;

a counter display which calculates the time interval corresponding to the count obtained by the counter and displays it in appropriate time units;

an operation panel which allows a user to program a recording schedule; and

a microcomputer which controls tape transport through the tape drive mechanism, input/output of signals by the signal input/output head, counting of control signals by the counter, reading of the counter display, and user programming via the operation panel; wherein

the microcomputer, when controlling the tape drive mechanism and signal input/output head through the user programming for recording via the operation panel so as to do video tape recording, controls the counter at the video recording start position to be reset, and controls the counter display to count/read the amount of tape transport;

after recording is over, it controls the tape drive mechanism to fast-rewind until the count is “29” or less, and controls the tape drive mechanism to give an instruction to stop the fast-rewinding;

after the tape stops running, it controls the tape drive mechanism to fast-forward until the signal input/output head reads a control signal three times and also the counter display shows that the time to reach the video recording start position is 1 sec. or less, and then instructs the tape drive mechanism to stop fast-forwarding, to thereby offset the tape overrun caused by fast-rewinding.

According to another aspect of the present invention, a video deck which measures the tape position according to prescribed positioning signals and reads increase or decrease on the counter display in units which are different from the measuring units used for the positioning signals, to thereby search the target stop position, comprising:

a variable speed tape transport means for fast-forwarding or fast-rewinding the tape at various speeds; and

a tape transport control means which controls the variable speed tape transport means to quickly run the video tape and also to give an instruction to stop the high speed tape transport when the counter display reads the same value as in the target stop position but the tape position as indicated by said positioning signals is short of the target stop position.

In this configuration according to the present invention, the tape position is measured based on prescribed positioning signals and the display counts up or down in a unit different from the unit measured through the positioning signals, so that the target stop position is reached. For this purpose, the video deck has a variable speed tape transport means and a tap transport control means, where the transport speed of the tape can be varied by means of the variable speed tape transport means to fast-forward or fast-rewind. And, the tape transport control means controls the variable speed tape transport means to make it transport the tape at high speed and start the action to stop the tape transport at high speed through the variable speed tape transport means when the display reads the same value as in the target stop position but the tape position as indicated by the positioning signals is short of the target stop position.

Generally, the counter display used on a video deck indicates an amount of tape transport in a unit system which is easy for the user to grasp intuitively. On the other hand, when positioning signals as mentioned above are used, the tape position can be measured; however, if an amount of tape transport should be indicated in the same units as those for the positioning signals, it would not be easy for the user to understand. For this reason, the unit system used for counter display readings is different from that used for the above-mentioned positioning signals, which means that a display reading does not directly show a tape position. Rather, a display reading implies a tape position range. Therefore, according to the present invention, the action to stop transport of the tape is started when the display reads a value identical to the display reading for the above-said target stop position and the tape position as indicated by the above-said positioning signals is short of the target stop position. This makes it possible to start the action to stop the tape before the exact target stop position is reached, thereby reducing tape overrun from the target stop position.

Furthermore, in this case, since the display reads the same value as the display reading showing the target stop position, the user will not think that the tape has stopped before the desired stop position is reached. This control is possible whether or not there are recorded positioning signals on the tape before the target stop position, so it is suitable for a case where after recording the tape is reversed toward the recording start position at high speed, followed by fast-forwarding to reach the start position. In other words, regardless of the tape condition before start of recording, a quick forwarding motion to offset the overrun can be started accurately after stop of a rewinding motion.

Here, it is sufficient that the tape position can be measured according to the prescribed positioning signals and thus positional relations can be defined with respect to various positional references. This covers the following various possible tape conditions in a video deck: a condition that the tape is pulled out of the cassette and wound around the drum head as during a reproducing process; a condition that the tape is in contact with the audio control head without being wound around the drum head as during high speed tape transport; and a condition that the tape is housed in a cassette. Under any of these conditions, once a specific reference position is determined for a certain tape condition, the tape position can be relatively defined by calculating the amount of tape transport with respect to that reference position or normal tape transport time or using any other method. For example, since an audio control head can detect control signals recorded on the tape, with reference to the condition that the tape is in contact with the audio control head, the tape position can be determined by using the control signals as positioning signals as mentioned above,.

According to the present invention, the user perceives as if the tape stop action starts after the display reading for the target stop position has been reached, so the user has no doubt about this process. In addition, this ensures that a shift to the fast-forwarding mode to offset the overrun after stop of rewinding is done accurately, thereby providing a video deck capable of searching the start of a recorded sequence accurately.

As discussed above, the present invention is effective for a case where a specific display reading corresponds to a range of tape positions. Another embodiment of this kind is composed of the following: a means for recording control signals on a tape; a means for detecting control signals recorded on the tape while the tape is being transported by the variable speed tape transport means; a counting means which resets the count at a specific target stop position and adds to or subtracts from the reset count either the number of control signals recorded on the tape by the control signal recording means or the number of control signals detected by the control signal detection means, or a combination of these, to perform counting; and a counter display means which calculates the tape transport time interval corresponding to the count obtained by the counting means and displays it in appropriate time units.

In the above-mentioned constitution, the prescribed positioning signals are control signals and display readings are in time units. Thus, the control signals are recorded on the tape by the control signal recording means and the control signal detection means detects the control signals recorded on the tape while the tape is being transported by the variable speed tape transport means. The counting means resets the count at a specific target stop position and adds to or subtracts from the reset count either the number of control signals recorded on the tape by the control signal recording means or the number of control signals detected by the control signal detection means, or a combination of these, to perform counting. The counter display means calculates the tape transport time interval corresponding to the count obtained by the counting means and displays it in appropriate time units.

Since control signals are recorded at regular time intervals, these control signals can be used for display readings in time units. For instance, in NTSC video decks, one control signal is recorded for two video tracks on the tape, or for one frame of image data. Hence, each time the control signal is detected by the control signal detection means 30 times, the display reading is incremented or decremented by one second, so that the display can show a tape transport time in time units when control signals have been recorded on the tape. Also, when the display reading is incremented by one second each time the control signal recording means records the control signal on the tape 30 times during video recording, the display can show a video recording time in time units.

In this kind of counter display system, because the display is not incremented or decremented unless the control signal is detected 30 times, a display reading implies a range of tape positions corresponding to 29 control signals. Therefore, assuming that the display reading in time units for the reset count representing the target stop position is “0:00:00 (0 hr. 00 min. 00 sec.)”, the display reading is still “0:00:00” even when the tape position is deviated from the target stop position by a range of 29 control signals, or somewhere before or after the target stop position. Hence, if the tape transport stop action is started when the display reading reaches “0:00: 00”, the stop action begins before the exact target stop position is reached, leading to a reduction in the amount of overrun from the target stop position.

Although the above explanation of display readings concerns a video deck for recording NTSC broadcasting signals, it is no need to say that the present invention is applicable to PAL or SECAM video decks. In the above explanation, it is assumed that the display reading for the target stop position is “0:00:00”, but even when the display reading for the target stop position is not “0:00:00”, the present invention can be applied as far as a display reading corresponds to a range of counted control signals.

Thus, the present invention may be applied to a video deck whose constitution allows the display reading for the target stop position to corresponds to a range of tape positions.

Various forms of means for deciding whether a display reading is identical to that for the target stop position are possible: one example is another embodiment of the present invention where the tape transport control means assumes that, when the count of control signals by the counting means reaches a prescribed number less than the number of control signals equivalent to 1 second in reproduction, the display shows the same value as the display reading for the target stop position.

In this constitution, when the count of control signals by the counting means reaches a prescribed count as a fraction of 1 second in reproduction, the tape transport control means decides that the current display reading is identical to the display reading for the target stop position, and starts the tape stop action. Usually, in conventional video decks, display readings are in time units and in most cases the minimum unit is a second. So if the number of control signals is not sufficient for a second, these fractional control signals are not indicated by the display.

From another viewpoint, since the count is reset at the recording start position, when the count reaches a prescribed number as a fraction of 1 second, the display reading in time units or seconds becomes identical to the display reading in seconds for the target stop position. So, by deciding whether this count is the prescribed number or not, the tape transport stop action can be started without the need for recording the display reading in seconds at the time of recording start or any similar process, when the display reading in seconds reaches that for the target stop position. In NTSC video decks as mentioned above, the prescribed number is 29; however, it can be varied depending on the broadcasting system or counter display technique employed.

Therefore, according to one aspect of the present invention, when the display reaches the reading for the target stop position, the tape transport stop action can be started easily.

According to another embodiment of the present invention, the prescribed number of control signals as a fraction of 1 second in reproduction maybe varied depending on the type of video deck; it may be a relatively large number for a model where the time interval from when the action to stop high speed tape transport by the variable speed tape transport means is started until the tape stops running is long, while it may be a relatively small number for a model where the above-said time interval is short.

In this constitution, the prescribed number of counted control signals, which is a fraction of the number of control signals equivalent to 1 second in reproduction, is variable depending on the capability of the brake in the variable speed tape transport means used in the video deck. As described above, in a situation where the display shows the same value as the display reading for the target stop position, it implies a range of control signal counts. The prescribed number of control signals as a fraction of 1 second in reproduction can be selected within this range of control signal counts: as this prescribed number is larger, the time required to reach the recording start position is longer while it is smaller, the time is shorter.

For a model where the time interval from when the action to stop high speed tape transport is started until the tape stops running is long, a larger number which allows the tape stop action to begin as far before the recording start position as possible is used as the prescribed number in order to minimize the overrun. As a result, the time to reverse the tape once stopped to the recording start position can be shortened. For a model where the time interval from when the action to stop high speed tape transport is started until the tape stops running is short, a smaller number is used as the prescribed number so that the tape stop action begins at a point nearer to the recording start position. As a result, the time from start of tape stop action until the recording start position is reached, including the time required to reverse the tape, can be shortened.

In this way, according to the present invention, the time from start of tape stop action until completion of program search can be shortened.

As stated above, the tape overrun must be offset for the recording start position to be reached after high speed tape transport. This offset is achieved in various ways. In another embodiment of the present invention as one example of offset control, the tape transport control means controls the variable speed tape transport means so that, in reversing the tape to the target stop position in order to offset the difference between two positions, the position where the tape has stopped after start of the tape stop action and the target stop position, the reverse motion is stopped when the prescribed number of control signals are detected by the control signal detection means.

In this constitution, the tape transport control means controls the variable speed tape transport means to reverse the tape to the target stop position in order to offset the difference between the position where the tape has stopped after start of the tape stop action and the target stop position. Here, upon detection of the prescribed number of control signals by the control signal detection means, the reverse motion is stopped. As stated earlier, if video recording is started midway on a blank tape, there is a tape area before the recording start position where no control signals are recorded and control signals are recorded after the recording start position.

Therefore, in a situation like this, detection of the prescribed number of control signals during the reverse motion means that the recording start position is reached, so the search is accurately done by stopping the reverse motion upon such detection. In this case, when the prescribed number of control signals are detected, the reverse motion is stopped. The reverse motion may be stopped upon detection of one control signal or, if the influence of noise is taken into consideration, three control signals or so. Since several control signals correspond to several frames, in most cases this degree of deviation from the recording start position does not cause an inconvenience for the user.

Hence, according to one aspect of the present invention, program search can be done accurately when no control signals are recorded on the tape before the recording start position.

Control signals are often recorded in an area of the tape before the recording start position, for example, when overwriting is done on the tape. In order to ensure that the search is done accurately even in such as case, according to another embodiment of the present invention, the tape transport control means controls the variable speed tape transport means so that in reversing the tape to the target stop position in order to offset the difference between the position where the tape has stopped after start of the tape stop action and the target stop position, the reverse motion is stopped when the prescribed number of control signals are detected by the control signal detection means and the counter display means shows that the time required to reach the target stop position is a prescribed time or less.

In this constitution, the tape transport control means controls the variable speed tape transport means to reverse the tape to the target stop position in order to offset the difference between the position where the tape has stopped after start of the tape stop action and the target stop position. Here, when the prescribed number of control signals are detected by the control signal detection means and the counter display means shows that the time required to reach the target stop position is a prescribed time or less, the reverse motion is stopped. As stated above, if overwriting is done on a tape where recording has been made, usually there are recorded control signals before the recording start position.

If the reverse motion should be stopped only on condition that the prescribed number of control signals are detected, the reverse motion would immediately stop just after its start and the recording start position could not be reached. According to the present invention, control signals are detected and counted and the display reads a value depending on the count, so even during a reverse motion, the time required to reach the recording start position is known by referring to the display reading. Then, whether or not the time required to reach the target stop position is a prescribed time or less is decided from the display reading and if it is decided to be the prescribed time or less, the reverse motion is stopped. Preferably this prescribed time interval should be almost equal to the time required to stop the reverse motion, a time from when the action to stop the reverse motion is started until the motion stops. As a result, the tape can be stopped almost at the recording start position.

Hence, according to one aspect of the present invention, the target stop position can be searched accurately, whether or not there are recorded control signals on the tape before the recording start position.

Here, to decide whether or not the control signal detection means has detected a prescribed number of control signals (hereinafter referred to as the first condition) is a condition for the case where there are no recorded control signals before the recording start position on the tape. On the other hand, to decide, from the reading by the counter display means, whether or not the time required to reach the target stop position is a prescribed time or not (hereinafter referred to as the second condition) is a condition for the case where there are recorded control signals before the recording start position on the tape.

According to the present invention, the reverse motion is stopped when both the first and second conditions are met, so that the system can cope with both cases, one that there are recorded control signals before the recording start position and the other that there are not. In the case that there are no recorded control signals before the recording start position on the tape, the count obtained by the counting means does not change so the display reading by the counter display means remains the same as the count for the recording start position.

Therefore, the second condition is met at the same time when the reverse motion begins, so actually only the first condition is a determinant factor. Hence, as the first condition is met, the recording start position can be reached. By contrast, if there are already recorded control signals before the recording start position on the tape, the prescribed number of control signals are detected just after start of the reverse motion and thus the first condition is immediately met. So only the second condition is a determinant factor. Hence, as the second condition is met, the recording start position can be reached. In other words, the recording start position can be searched accurately, whether or not there are recorded control signals before the recording start position.

In a video deck according to the present invention, the user perceives as if the tape stop action has started after the display reading for the target stop position has been reached, so the user has no doubt about this process. In addition, this ensures that a shift to the fast-forward mode to offset the overrun after stop of rewinding is done accurately. This provides a video deck capable of searching a target stop position accurately, whether or not there are recorded control signals before the recording start position.

In this way, the present invention takes the following approach: the tape stop action is started when the display shows the same value as the display reading for the target stop position and the tape position as indicated by the positioning signals is short of the target stop position. It can be easily understood that this approach can be realized not only by an actual device but also as a method. Therefore, according to another embodiment of the present invention, a video deck which can forward or rewind the tape at various speeds, uses a video deck control method to measure the tape position according to prescribed positioning signals and increments or decrements the display reading in units which are different from the measuring units used for the positioning signals in a way that the target stop position is searched, where the tape is transported at high speed through the variable speed tape transport means and the action to stop the tape is started when the display shows the same value as the display reading for the target stop position but the tape position as indicated by the positioning signals is short of the target stop position.

It is obvious that this can be achieved not only by an actual device but also as a method.

This type of video deck may be a standalone unit or part of equipment and the concept of the present invention includes various forms of embodiments, so it can be embodied as software or hardware.

If the concept of the invention is to be embodied in the form of a video deck software program, apparently it can exist and be available as a program or a program stored in a recording medium.

For example, another form of embodiment is a video deck control program or a video deck control program recording medium, to be used with a video deck which can forward or rewind the tape quickly at various speeds, which allows a computer to work so as to measure the tape position according to prescribed positioning signals and increment or decrement the display reading in units which are different from the measuring units used for the positioning signals in a way that the target stop position is searched, where the tape is transported at high speed through the variable speed tape transport means and the action to stop the tape is started when the display shows the same value as the display reading for the target stop position but the tape position as indicated by the positioning signals is short of the target stop position.

The recording medium may be a magnetic recording medium, a magneto-optic recording medium or any other recording medium which will be developed in the future. It is out of question that any level of replication of the program (for example, a primary or secondary copy of it) is as effective as the original. Even when it is distributed through a communication line, it is effective as well.

There is no departure from the concept of the invention even when it is embodied partly as software and partly as hardware; it is also acceptable that some part of the program is stored in a recording medium and loaded from the medium as necessary.

An embodiment of the present invention as software may be integrated into some hardware or an operating system or used separately from it. It can be understood that, when the program to be used under an operating system is commercially distributed in a recording medium containing it, it embodies the invention alone.

When the present invention is embodied as software, it may be not only in the form of a medium recording such a program but also in the form of a program. The present invention also includes such a program.

Other and further objects, features and advantages of the invention will appear more fully from the following description.

### BRIEF DESCRIPTION OF THE DRAWINGS

A preferred form of the present invention illustrated in the accompanying drawings in which:

FIG. 1 is a block diagram illustrating a video deck according to an embodiment of the present invention;

FIG. 2 shows a video tape transport path for recording or reproduction;

FIG. 3 schematically shows a video tape signal recording pattern;

FIG. 4 shows a video tape transport path for fast-forwarding or fast-rewinding;

FIG. 5 is a flowchart for counter display reading;

FIG. 6 is a flowchart for reserved recording;

FIG. 7 schematically shows one example of a video tape signal recording pattern; and

FIG. 8 schematically shows another example of a video tape signal recording pattern.

### DESCRIPTION OF THE PREFFEREED EMBODIMENTS

Preferred embodiments of the present invention will be described next referring to the attached drawings.

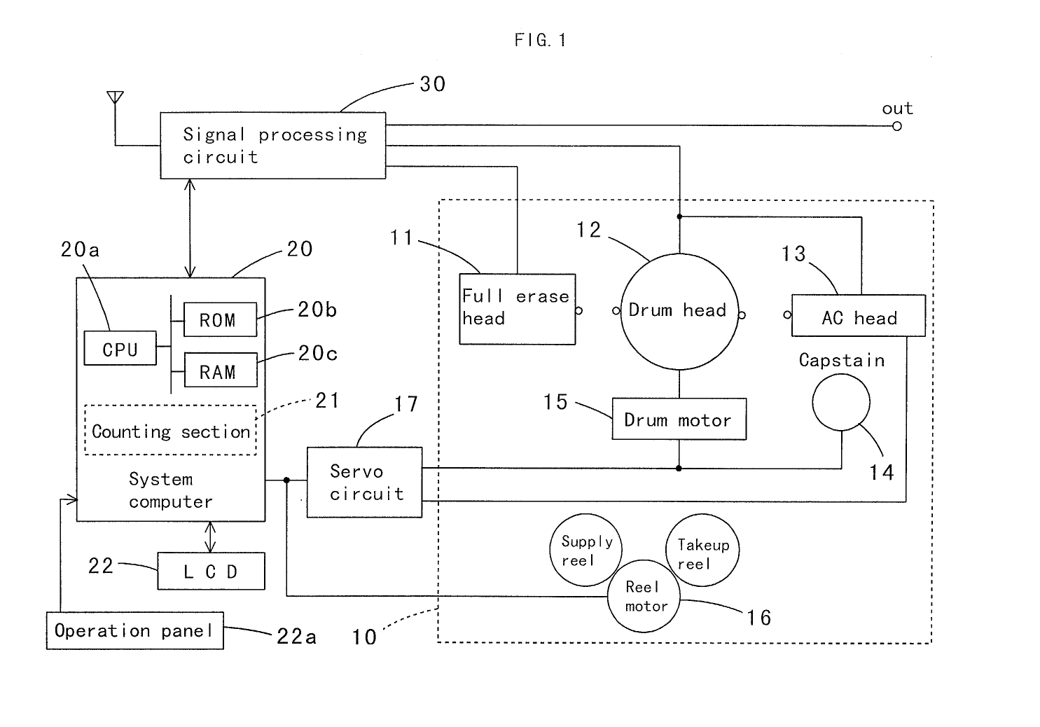

FIG. 1 is a block diagram illustrating a video deck according to an embodiment of the present invention. As shown in the figure, a full erase head 11, a drum head 12, and an AC (audio control) head 13 are incorporated in a tape drive mechanism 10 together with a capstan 14, a drum motor 15 and a reel motor 16. The heads 11 to 13 constitute a signal input/output head. The capstan 14, drum motor 15 and AC head 13 are connected to a servo circuit 17, which is in turn connected to a system computer 20 together with the reel motor 16. The servo circuit 17 performs feedback control of the capstan 14 and drum motor 15 according to PG pulses representing rotation of the drum head 12, FG pulses representing rotation of the capstan, and control signals outputted from the AC head 13. Along with the reel motor 16, it is controlled by the system computer 20 so that tape transport is adequately done at various speeds.

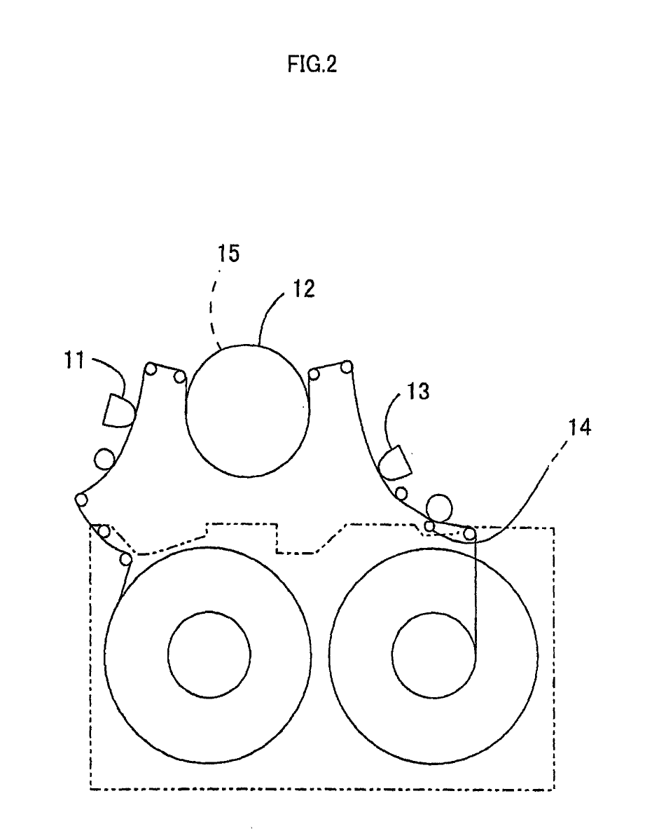

FIG. 2 shows a path through which the tape runs during recording or reproduction (replay); the full erase head 11, drum head 12 and AC head 13 are located along the tape transport path in the order shown here. As shown in the figure, for recording or reproduction, the tape is pulled out and guided through tape guide posts and back tension posts so that the tape is in contact with the full erase head 11, drum head 12 and AC head 13. The capstan 14 and a pinch roller are pushed against each other to have the tape transported as the capstan 14 rotates.

The system computer 20, which incorporates a microcomputer composed of a CPU 20a, ROM 20b, RAM 20c and so on, is connected to a signal processing circuit 30 composed of a tuner, VIF, RF converter, etc. By controlling the VIF, etc. in the signal processing circuit 30 in an adequate sequence, signals for video recording or reproduction are generated. This means that a video signal generated through an antenna is sent to the drum head 12 and AC head 13 in the tape drive mechanism 10 and the drum head 12 records video tracks on a loaded video tape while the AC head 13 records a sound track and control signals on the tape. At the same time, the full erase head 11 is driven to make full-width erasure of the tape before recording of video tracks, etc. The ROM 20b stores a program, etc to enable the CPU 20a to perform various control tasks; in this sense, it serves as a program recording medium. Apparently, the ROM 20b may be incorporated in the system computer 20 or externally connected to the computer through a bus (not shown).

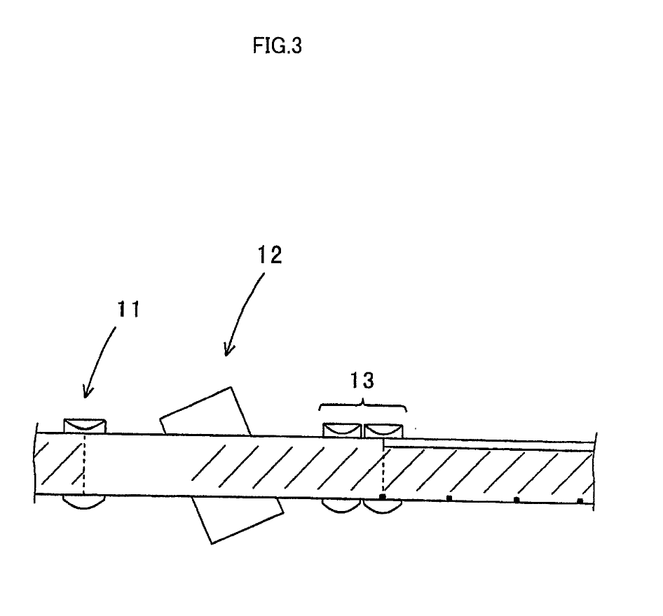

FIG. 3 is a schematic diagram showing such a video tape signal recording pattern. As shown in the diagram, after the tape is subjected to full-width erasure by the full erase head 11, the drum head 12 records video tracks on the tape obliquely with respect to the direction of tape transport and the AC head 13 records a sound track at the top of the tape and control signals at the bottom. This embodiment is designed as a NTSC video deck, where one video track corresponds to one field and one control signal is recorded for two video tracks. Thus, the AC head constitutes a control signal recording means as mentioned earlier.

As the system computer 20 drives the tape drive mechanism 10, a reproduction video signal generated according to data recorded on the tape is sent to the signal processing circuit 30 and subjected to such processes as extraction of luminance and carrier chrominance signals and amplification of reproduction signals before composite video signals generated by combined YC signals are outputted through RCA pin plug. The signal processing circuit 30 processes sound and reproduction signals in a prescribed manner and outputs them as reproduction/sound signals. Switching between the video recording mode and the video reproducing mode takes place according to recording/reproducing switching signals sent from the system computer 20. As a matter of course, video output does not necessarily need the configuration as mentioned above; instead an RF converter may be used to generate RF signals.

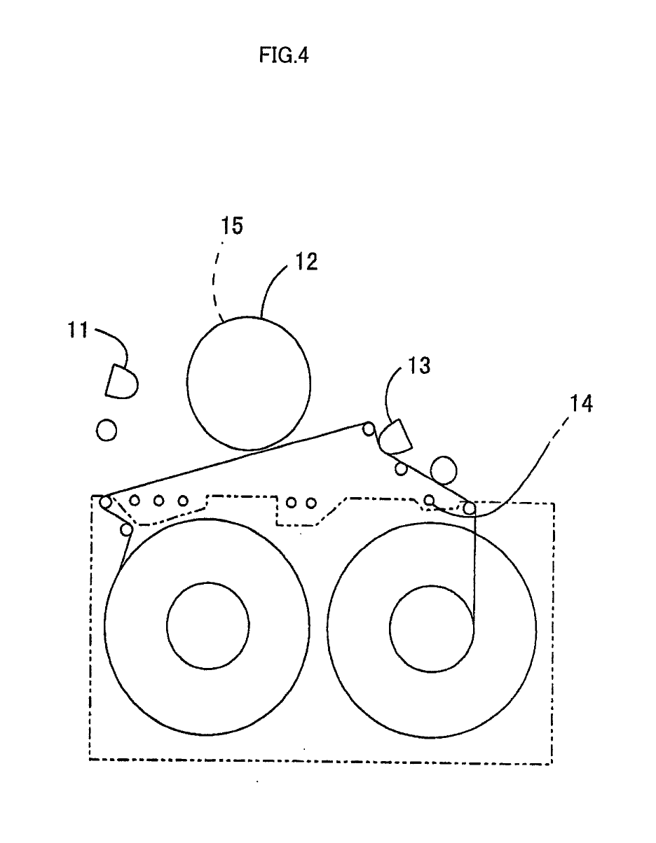

In the fast-forward or rewind mode, the tape is in the “half-loaded” state as shown in FIG. 4 where data can be read by the AC head 13. Controlled by the system computer 20, the reel motor 16 rotates the supply reel or take-up reel. In this condition, since the tape is in contact with the AC head 13, the control signals recorded on the tape can be detected by the AC head 13. Thus, the capstan 14, reel motor 16 and servo circuit 17 constitute a variable speed tape transport means as aforementioned, and the AC head constitutes a control signal detection means as aforementioned.

In addition, the system computer 20 is equipped with a counting section 21 and connected to a liquid crystal display 22 and an operation panel 22a so that the time of tape transport at normal speed from the recording start position is displayed according to the number of control signals recorded and detected by the AC head. The counting section 21 has a specific counter prepared to be reset at the time of start of recording and increments the counter each time a control signal is recorded. Control signals are counted in the following way: in the fast-forward or fast-rewind mode, control signals inputted through the servo circuit 17 are detected, and during tape transport in the reproducing direction the counter is incremented upon each such detection, and during tape transport in the rewinding direction, it is decremented upon each such detection.

The LCD 22 has a counter display area (display or readout) which shows, for example, “0:00:00” (0 hr. 00 min. 00 sec.) and changes the displayed numbers; it expresses the tape position at the time of initialization or resetting of the counter as “0:00:00”. Since this embodiment is in accordance with NTSC, 30 control signals correspond to “1” second; thus the system computer 20 controls the LCD 22 so as to increment the reading by “1” second each time the counter is incremented 30 times, and decrement the reading by “1” second each time the counter is decremented 30 times.

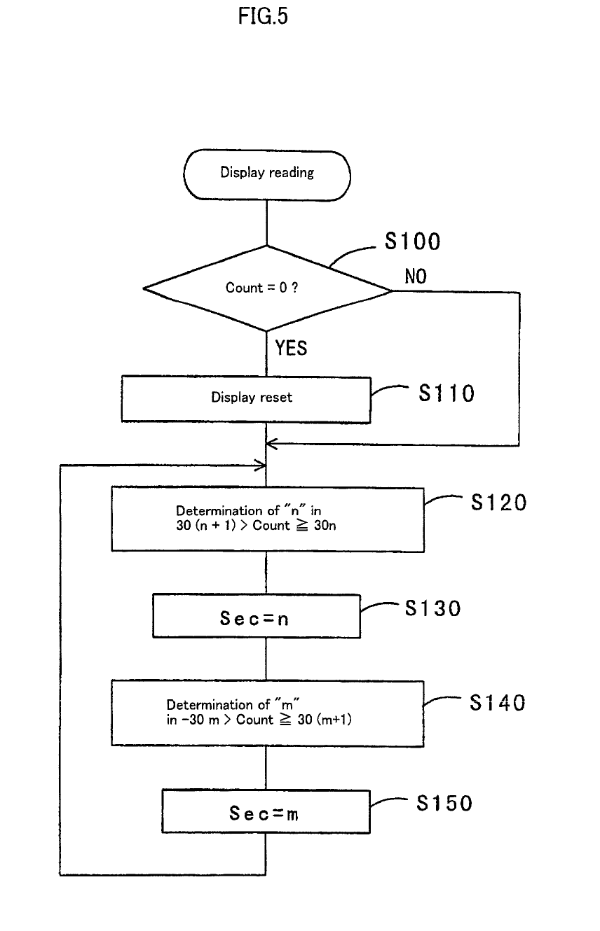

FIG. 5 shows a work flow to be performed by the system computer 20 for display readings. At step S100, a check is made as to whether the prepared counter has been reset. If so, the reading of the LCD is reset to “0:00:00” at step 110. At step 120 and subsequent steps, a process is performed to reflect the count check and the result of the check in the display reading.

At step 120 and subsequent steps, the count is incremented or decremented independently of the display reading process but depending on video recording or tape transport. Specifically, at step 120, the value of n which allows the count to be a value between 30n and 30 (n+1) (here n denotes a positive natural number) is determined; at step 130, the value of n is displayed as a number in the digits of seconds. For example, if the count is between 0 and 29, n is 0 and the digits of seconds are 00. If the count is between 30 and 59, n is 1 and the digits of seconds are “01”. When the digits of seconds exceed “60”, the digits of seconds are cleared and the digits of minutes are incremented; when the digits of minutes exceed “60” (minutes), the digits of minutes are cleared and the digit of hours is incremented.

At step S140, the value of m which allows the count to be a value between −30 (m+1) and −30m (here m denotes a positive natural number) is determined; at step 150, the value of m is displayed as a number in the digits of seconds. For example, if the count is between −30 and −59, m is 1 and the digits of seconds are “−01”. Again like at step 130, the process for digit place advancement is taken. At step S150 and subsequent steps, the steps from step S120 are repeated again. In this way, as the count is incremented or decremented, the reading of the LCD 22 changes accordingly. Thus, in this embodiment, the counting section 21 of the system computer 20 constitutes a counting means as aforementioned and the system computer 20 and LCD 22 serve as a counter display means as aforementioned.

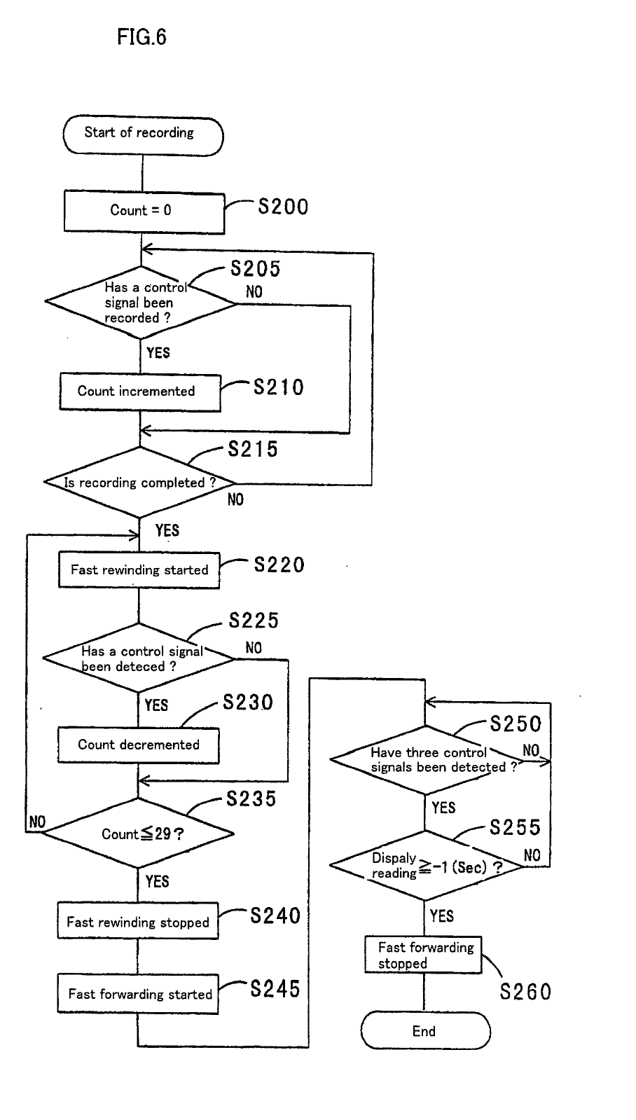

Furthermore, according to this embodiment, via the operation panel 22a, the user can enter programming information which consists of a recording start time, end time and channel No. The system computer 20 incorporates a timer circuit (not shown); when the current time as defined by the timer circuit and the pre-selected recording start time coincide, the system computer 20 works to start video recording from the pre-selected channel, then when the current time and the pre-selected recording end time coincide, the recording is ended. In this embodiment, after the recording as programmed is over, the system computer 20 performs a sequence of steps as shown in FIG. 6 to fast-rewind and locate the recording start position.

When the pre-selected recording start time and the current time coincide as mentioned above, at step S200, the prepared counter is reset to “0”. Then, the system computer 20 controls the signal processing circuit 30 to generate video signals from signals received through an antenna and send them to the drum head 12 and AC head 13 in the tape drive mechanism 10, and controls the servo circuit 17 to transport the tape adequately to start video recording. As video recording is thus started, at step 205, the system computer 20 decides whether or not a control signal (CTL) has been recorded on the tape by means of the AC head 13, and if at step S205 it is acknowledged that a control signal has been recorded, the count is incremented at step S210.

At step S215, a check is made as to whether or not the current time and the pre-selected recording end time coincide and programmed recording is completed; the counter incrementing sequence at step S215 and subsequent steps is continued until it is acknowledged at step S215 that programmed recording is completed. Namely, the count is continuously incremented during video recording. At the same time, the counter display routine as shown in FIG. 5 is executed, so the reading of the LCD 22 is also incremented according to the count. When it is acknowledged at step S215 that programmed recording is completed, step S220 and subsequent steps are taken to locate the recording start position.

At step S220, the system computer 20 controls the tape drive mechanism 10 to bring the tape into its half-loaded state, and also controls the reel motor 16 to rotate the take-up reel at high speed to fast-rewind. During fast-rewinding, whether or not a control signal has been detected by means of the AC head 13 is checked at step S225. If at step S225 it is acknowledged that a control signal has been detected, the count is decremented at step S230. At step S235, whether or not the count is 29 or less is checked and step S220 and subsequent steps for fast-rewinding are repeated until at step S235 it is acknowledged that the count is 29 or less.

When at step S235 it is acknowledged that the count is 29 or less, the procedure for stopping the fast-rewinding motion is started at step S240. At this moment, the system computer 20 brakes the reel motor 16 to stop its rotation; however, because the take-up reel is rotated at high speed for fast-rewinding, it is not stopped immediately, but after it is rotated by inertia, it is gradually stopped in order to avoid a sudden application of tension to the tape which may damage it. Even during this stop action, the AC head 13 continues to detect control signals and decrement the count.

After the take-up reel stops and the fast-rewinding motion stops, the tape overruns the recording start position due to the inertia and reaches a position before it. Therefore, at step S245, in order to reach the recording start position, the system computer 20 controls the reel motor 16 to rotate the supply reel to fast-forward. At this time, the tape is in its half-loaded state and control signals can be detected by the AC head 13. At step S250, whether or not three control signals have been detected is checked and this check is repeated until it is acknowledged at step S250 that three control signals have been detected.

When detection of three control signals is acknowledged at step S250, at step S255, reference to the reading of the LCD 22 is made to check whether or not it is “−0:00:01” or more. Step S250 and subsequent steps are repeated until it is acknowledged at step S250 that the reading of the LCD 22 is “−0:00:01” or more, and when it is so acknowledged at step S255, the fast-forwarding motion is stopped at step S260. In other words, when the logical product from both steps S250 and S255 is true, the system proceeds to step S260. Steps S220 to S260 taken by the system computer 20 are equivalent to the variable speed tape transport means. In this embodiment, the present invention is applied to search the start of a recorded sequence after completion of programmed recording. However, it does not necessarily presume that video recording is done; it can be applied to such a system where a specific target stop position is preset and fast-rewinding and fast-forwarding to search that position is carried out.

Next, an explanation will be given of how this embodiment with the above-said constitution works.

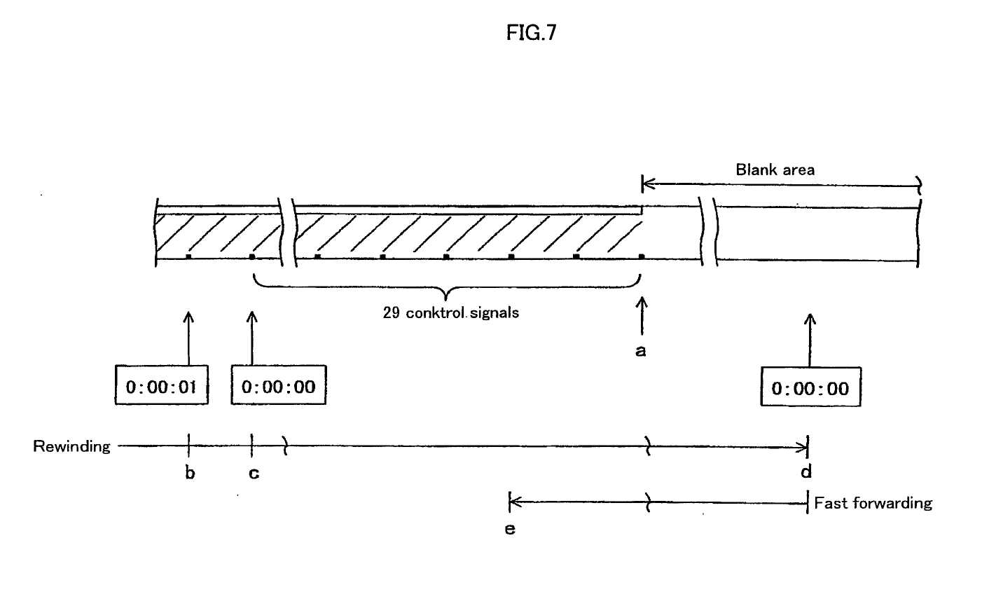

FIG. 7 schematically shows an example of a signal recording pattern on the tape in a video deck according to this embodiment. The figure shows that in rewinding, the tape is transported from the right to the left and the hatched area in the center of the tape represents video tracks and the area at the top of the tape a sound track and black dots at the bottom of the tape control signals. This example shows that video recording is started midway on a new tape or at position a. Therefore, there is no recording of video and sound tracks and control signals before recording start position a.

As video recording begins at the recording start position a, the counter is reset to “0” at step S200 and the reading of the LCD 22 becomes “0:00:00” at step S110 and video and sound tracks and control signals are recorded after the recording start position a. Each time a control signal is recorded, the count is incremented through steps S205 and S210 and the LCD 22 counts up according to the determination of n at step S120. At steps S120 and S130, the value n remains “0” until the count reaches “29” so the LCD reading remains “0:00:00”.

When the count reaches “30”, n becomes “1” at steps S120 and S130 and the LCD 22 reads “0:00:01”. The count of control signals and the reading of the LCD 22 increase in this way. When the recording end time is reached, video recording is ended and at step S215 it is acknowledged that programmed recording has been completed. After that, fast-rewinding begins at step S220 and the AC head 13 detects control signals, and the count is decremented at steps S225 and S230 while the tape is being rewound.

While the count is being decremented, the value of n is determined at steps S120 and S130 and the reading of the LCD 22 is decremented as well. As the tape being rewound approaches the recording start position a and reaches position b and then position c, the reading of the LCD 22 changes from “0:00:01” to “0:00:00”. At this moment, the count is “29” and the procedure to stop fast-rewinding begins as a result of decision at step S235.

In this procedure to stop fast-rewinding, the tape is transported to position d by inertia because of the high speed take-up reel rotation. The count continues to be decremented as control signals are detected by the AC head but since there are no recorded control signals before the recording start position a, the count never becomes below “0”. Therefore, the value of n is still “0” at steps S120 and S130 and the reading of the LCD 22 remains “0:00:00” at position d. After stop of rewinding, fast-forwarding begins at step S245 and a decision is made at step S250. Because there are no recorded control signals from position d to position a, rewinding continues as a result of decision at step S250.

There are recorded control signals after the recording start position a, so control signals are detected after position a; at position e where three control signals have been recorded, the procedure of step S255 begins. At step S255, reference is made to the reading of the LCD 22, and as stated above, the reading of the LCD 22 is “0:00:00”, namely above “−0:00:01”, SO the procedure of step S260 begins and fast-forwarding stops. Thus, with the above-mentioned procedures, the tape stops around position e. This position d is not the same as the recording start position a; yet three control signals correspond to one tenth of a second on the NTSC basis and the user recognizes no difference between the stop at position d and the one at the exact recording start position a.

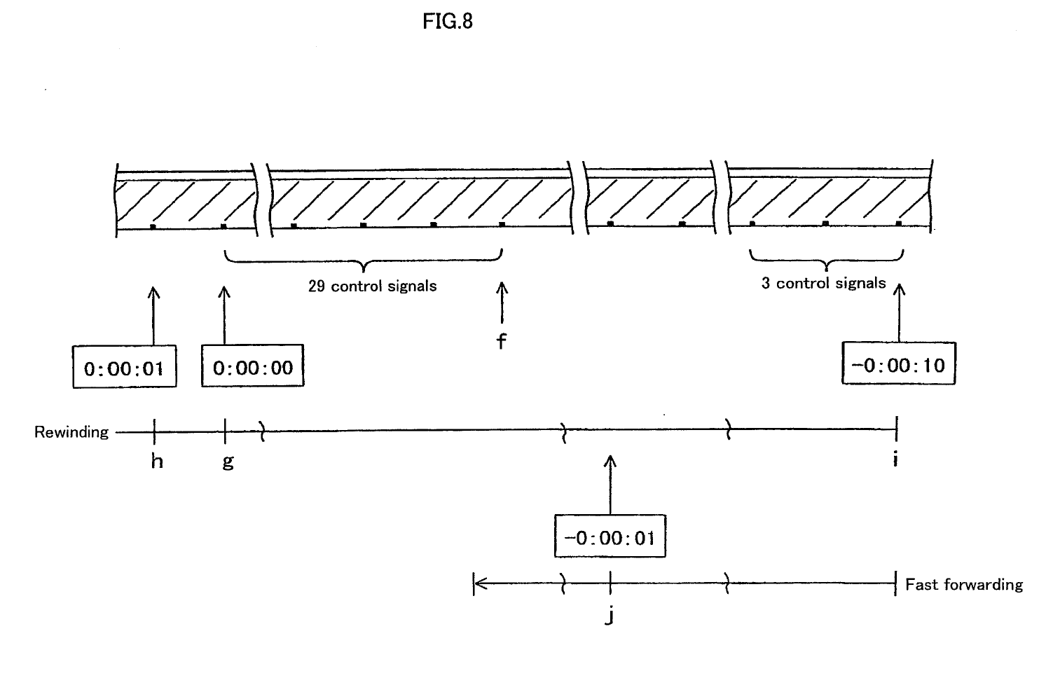

FIG. 8 schematically shows another example of a signal recording pattern on the tape according to this embodiment. The figure shows that in rewinding, the tape is transported from the right to the left and the hatched area in the center of the tape represents video tracks and the area at the top of the tape a sound track and black dots at the bottom of the tape control signals. This example shows that the already recorded tape is overwritten by recording from recording start position f, which means that there are already recorded video and sound tracks and control signals before and after the recording start position f.

As video recording begins at the recording start position f, the counter is reset to “0” at step S200 and the reading of the LCD 22 becomes “0:00:00” at step S110 and video and sound tracks and control signals are overwritten after the recording start position f. Each time a control signal is recorded, the count is incremented through steps S205 and S210 and the LCD 22 counts up according to determination of n at step S120. Like the example shown in FIG. 7, the reading of the LCD 22 remains “0:00:00” before position g where the count reaches “29”, and it counts up to “0:00:01” and so on after position h where the count reaches “30” as video recording goes on.

When the recording end time is reached, video recording is ended, fast-rewinding begins after steps S215 and S220. Again, like the example in FIG. 7, the reading of the LCD 22 is decremented and when the tape passes position h and reaches position g, the reading of the LCD 22 changes from “0:00:01” to “0:00:00”. At this moment, the count is “29” and the procedure to stop fast-rewinding begins as a result of decision at step S235 and the tape is transported to position i by inertia.

In this example, because there are recorded control signals before the recording start position f, the count continues to be decremented and finally becomes a negative number. So, the value of m is determined at steps S140 and S150 and the reading of the LCD 22 is decremented accordingly, which continues until the reading of the LCD 22 is “−0:00:10” at position i. After stop of rewinding at position i, fast-forwarding begins at step S245 and a decision is made at step S250. Since there are recorded control signals just before position i, the count is incremented and the requirement for step S250 is met just after start of fast-forwarding at step S245.

Further, the decision at step S255 is carried out in the following sequence. The reading of the LCD 22 is around “−0:00:10” just after start of fast-forwarding at step S245 and decisions at step S250 and subsequent steps are made repeatedly. As the count is continuously incremented, the reading of the LCD 22 continues to be incremented and becomes “−0:00:01” at position j, when, as a result of the decision at step S255, step S260 is initiated and fast-forwarding stops. During this process, the tape transport is controlled so that the procedure to stop fast-forwarding begins at position j and the tape stops around the recording start position f.

As discussed so far, according to the present invention, in order to locate a desired target stop position while the display counts up or down as the tape is transported, the action to stop the tape is started when the display shows the same value as the display reading for the target stop position. Then, when the tape is reversed to offset the overrun due to inertia, the tape transport is controlled so that the above-said reverse motion stops when a prescribed number of control signals have been detected and the display shows that the time required to reach the target stop position becomes a prescribed time or less. Consequently, the target stop position can be searched accurately, whether or not there are recorded control signals on the tape.

The foregoing invention has been described in terms of preferred embodiments. However, those skilled, in the art will recognize that many variations of such embodiments exist. Such variations are intended to be within the scope of the present invention and the appended claims.

We claim:

1. A video deck which comprises:
a tape drive mechanism for fast-forwarding or fast-rewinding the tape in a loaded video cassette at various transport speeds;
a signal input/output head which records on/reads from the tape, NTSC control signals and prescribed video signals while the tape is being transported by the tape drive mechanism;
a counter which resets the count at the video recording start position and adds to/subtracts from the reset count either the number of control signals for the signal input/output head to record on the tape or the number of control signals for the signal input/output head to detect from the tape, or a combination of these;
a counter display which calculates the time interval corresponding to the count obtained by the counter and displays it in appropriate time units;
an operation panel which allows a user to program a recording schedule; and
a microcomputer which controls tape transport through the tape drive mechanism, input/output of signals by the signal input/output head, counting of control signals by the counter, reading of the counter display, and user programming via the operation panel; wherein
the microcomputer, when controlling the tape drive mechanism and signal input/output head through the user programming for recording via the operation panel so as to do video tape recording, controls the counter at the video recording start position to be reset, and controls the counter display to count/read the amount of tape transport;
after recording is over, it controls the tape drive mechanism to fast-rewind until the count is “29” or less, and controls the tape drive mechanism to give an instruction to stop the fast-rewinding;
after the tape stops running, it controls the tape drive mechanism to fast-forward until the signal input/output head reads a control signal three times and also the counter display shows that the time to reach the video recording start position is 1 sec. or less, and then instructs the tape drive mechanism to stop fast-forwarding, to thereby offset the tape overrun caused by fast-rewinding.

2. A video deck which measures the tape position according to prescribed positioning signals and reads increase or decrease on the counter display in units which are different from the measuring units used for the positioning signals, to thereby search the target stop position, comprising:
a variable speed tape transport means for fast-forwarding or fast-rewinding the tape at various speeds; and
a tape transport control means which controls the variable speed tape transport means to quickly run the video tape and also to give an instruction to stop the high speed tape transport when the counter display reads the same value as in the target stop position but the tape position as indicated by said positioning signals is short of the target stop position.

3. The video deck according to claim 2, further comprising:
a control signal recording means for recording control signals on a tape;
a control signal detection means for detecting the control signals recorded on the tape while the tape is being transported by the variable speed tape transport means;
a counting means which resets the count at a target stop position and adds to/subtracts from the reset count either the number of control signals for the control signal recording means to record on the tape or the number of control signals for the control signal detection means to detect from the tape, or a combination of these; and
a counter display means which calculates the tape transport time interval corresponding to the count obtained by the counting means and displays it in appropriate time units.

4. The video deck according to claim 3,
wherein the tape transport control means assumes that, when the count of control signals by the counting means reaches a prescribed number equivalent to a fraction of 1 second in reproduction, the counter display shows the same value as in the target stop position.

5. The video deck according to claim 4, wherein the prescribed number of control signals equivalent to a fraction of 1 second is set to be large where interval is long while to be small where the interval is short, the interval defining time interval from the time when the variable speed tape transport means gives an instruction to stop high speed tape transport, to the time when the tape stops running.

6. The video deck according to claim 3, wherein upon detection of the prescribed number of control signals by the control signal detection means, the tape transport control means controls the variable speed tape transport means to stop reverse motion, the reverse motion defining offset of the difference between the tape stop position after an instruction to stop high speed tape transport is given and target stop position.

7. The video deck according to claim 3, wherein when the control signal detection means detects the prescribed number of control signals and the counter display shows that the time required to reach the target stop position becomes a prescribed time interval or less, the tape transport control means controls the variable speed tape transport means to stop reverse motion, the reverse motion defining offset of the difference between the tape stop position after an instruction to stop high speed tape transport is given and target stop position.

8. A method for controlling a video deck which can fast-forward or fast-rewind a video tape at various speeds, to measure the tape position according to prescribed positioning signals and read increase or decrease on the counter display in units which are different from the measuring units used for the positioning signals, to thereby search the target stop position, comprising the steps of:
allowing the variable speed tape transport means to quickly run the video tape;
giving an instruction to stop the high speed tape transport when the counter display reads the same value as in the target stop position but the tape position as indicated by said positioning signals is short of the target stop position.

9. A medium which stores a video deck control program for controlling a video deck able to fast-forward or fast-rewind a video tape at various speeds, to measure the tape position according to prescribed positioning signals and read increase or decrease on the counter display in units which are different from the measuring units used for the positioning signals, to thereby search the target stop position,
wherein the program allows the variable speed tape transport means to quickly run the video tape; and
gives an instruction to stop the high speed tape transport when the counter display reads the same value as in the target stop position but the tape position as indicated by said positioning signals is short of the target stop position.
